(19) United States
(12) Patent Application Publication
(10) Pub. No.: US 2007/0177169 A1
(43) Pub. Date: Aug. 2, 2007

(54) DEVICE TO DRIVE RECORDING ELEMENTS OF A PRINT HEAD AND AN IMAGE FORMING APPARATUS HAVING THE SAME

(76) Inventor: Eun-bong HAN, Suwon-si (KR)

Correspondence Address: STANZIONE & KIM, LLP, 919 18TH STREET, N.W., SUITE 440, WASHINGTON, DC, 20006, US

(21) Appl. No.: 11/553,050

(22) Filed: Oct. 26, 2006

(30) Foreign Application Priority Data
Feb. 2, 2006 (KR) 2006-10050

(51) Int. Cl. G06K 15/10

(52) U.S. Cl. 358/1.8; 347/20

(57) ABSTRACT

A device to select and drive recording elements included in a print head that prints images, for example, a nozzle. The device includes an encoder to encode address data, a decoder to decode the encoded address data to restore original address data, an address data bus to connect the encoder with the decoder to transfer the encoded address data to the decoder, a driver to drive the recording elements using the primitive data and the decoded address data, and a primitive data bus to transfer the primitive data to the driver. Accordingly, when the recording elements included in the print head are driven using the primitive data and the address data, the address data can be encoded so that neighboring recording elements share the address data bus to reduce the number of address data bus lines and a size of a print head chip.

### CROSS-REFERENCE TO RELATED APPLICATIONS

This application claims the benefit of Korean Patent Application No. 10-2006-0010050, filed on Feb. 2, 2006, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to a device to select and drive recording elements included in a print head of an image forming apparatus.

2. Description of the Related Art

An ink jet image forming apparatus forms images by jetting (i.e., ejecting) ink from a print head, which is located a predetermined distance from a print medium and is reciprocated in a direction perpendicular to a print medium transfer direction. This type of image forming apparatus is referred to as a shuttle type ink jet image forming apparatus. The print head of the shuttle type ink jet image forming apparatus includes a nozzle unit having a plurality of nozzles for jetting ink.

Recently, image forming apparatuses having an array head have been developed. The array type image forming apparatuses rapidly print high quality images using a print head having the same width and/or length as a print media, without horizontally moving the print head. These image forming apparatuses with the array head have a large number of recording elements included in the print head that prints images on the media.

In order to drive the large number of recording elements in the array type image forming apparatuses, a large amount of power is consumed, and thus, a time division driving method is used. The time division driving method divides the recording elements into a plurality of groups and sequentially drives the plurality of groups. The time division driving method selects groups to be driven from the plurality of groups using primitive data and selects recording elements to be driven from the recording elements belonging to the selected groups using address data. Accordingly, address data buses corresponding to the number of the plurality of groups and address data buses corresponding to the number of the recording elements included in the plurality of groups are required.

The size of a print head chip used by the image forming apparatuses can be reduced, because the size of a transistor constructing the print head chip decreases and a circuit pitch becomes narrower when a CMOS process is employed. However, regarding the address data bus used for the time division driving method, lines are long and the number of lines is large so that a line width and a line interval cannot be reduced for correct signal transmission.

### SUMMARY OF THE INVENTION

The present general inventive concept provides a device to drive recording elements of an image forming apparatus, which is capable of reducing a number of lines of data buses that transfer primitive data and address data to drive the recording elements.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a device to drive recording elements of an image forming apparatus, which includes an encoder to encode address data, a decoder to decode the encoded address data to restore original address data, an address data bus to connect the encoder with the decoder to transfer the encoded address data to the decoder, a driver to drive the recording elements using primitive data and the decoded address data, and a primitive data bus to transfer the primitive data to the driver.

The encoder may encode the address data so that neighboring recording elements from among the recording elements share the address data bus.

When the recording elements are divided into four groups, the address data bus may include four address data buses that transfer the address data to the four groups, respectively, and the primitive data bus may include four primitive data buses that transfer the primitive data to the four groups, respectively.

The encoder may convert the address data into BCD codes so that recording elements corresponding to addresses having the same predetermined upper bits of the BCD codes share the address data bus.

Each lower bit below the predetermined upper bits of the BCD codes may be provided to the decoder through a single address data bus.

The recording elements may include ink jet nozzles to eject ink onto media to form images.

The foregoing and/or other aspects of the present general inventive concept are also achieved by providing a device to drive nozzle groups in a print head, the device including a print head having a plurality of nozzle groups with N nozzles in each group, and a driving signal generator to receive X address bits of an address signal indicating which nozzles within a selected nozzle group are to be driven and to decode the X address bits into N address bits, N being greater than X, and to drive nozzles of the selected nozzle group which correspond to the N address bits.

The foregoing and/or other aspects of the present general inventive concept are also achieved by providing an image forming apparatus, including a print head having a plurality of groups of nozzles, each group having a plurality nozzles, an encoder to receive an address signal having a plurality of first bits to select from the plurality of nozzles in a selected nozzle group and to reduce the first bits in the address signal to a plurality of second bits based on relative locations of the nozzles within the selected nozzle group, and a driving signal generator to receive the second address bits, to restore the first bits of the address signal, and to drive the nozzles in the selected nozzle group based on the restored first bits.

The foregoing and/or other aspects of the present general inventive concept are also achieved by providing a method of driving a print head having a plurality of nozzle groups with N nozzles in each group, the method including receiving X address bits of an address signal indicating which nozzles within a selected nozzle group are to be driven, decoding the X address bits into N address bits, N being greater than X, and driving nozzles of the selected nozzle group which correspond to the N address bits.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a device to drive recording elements of an image forming apparatus according to an embodiment of the present general inventive concept;

FIGS. 2A and 2B illustrate configurations of data buses that transfer primitive data and address data according to an embodiment of the present general inventive concept;

FIG. 3 illustrates a method of encoding address data according to an embodiment of the present general inventive concept; and

FIG. 4 illustrates a configuration of a decoder to decode address data, as illustrated in FIG. 1 according to an embodiment of the present general inventive concept.

### DETAILED DESCRIPTION OF THE PREFERRED EMBODIMENTS

The present general inventive concept will now be described more fully with reference to the accompanying drawings, in which exemplary embodiments of the general inventive concept are illustrated. The general inventive concept may, however, be embodied in many different forms and should not be construed as being limited to the embodiments set forth herein. Rather, these embodiments are provided so that this disclosure will be thorough and complete, and will fully convey the concept of the general inventive concept to those skilled in the art. Throughout the drawings, like reference numerals refer to like elements.

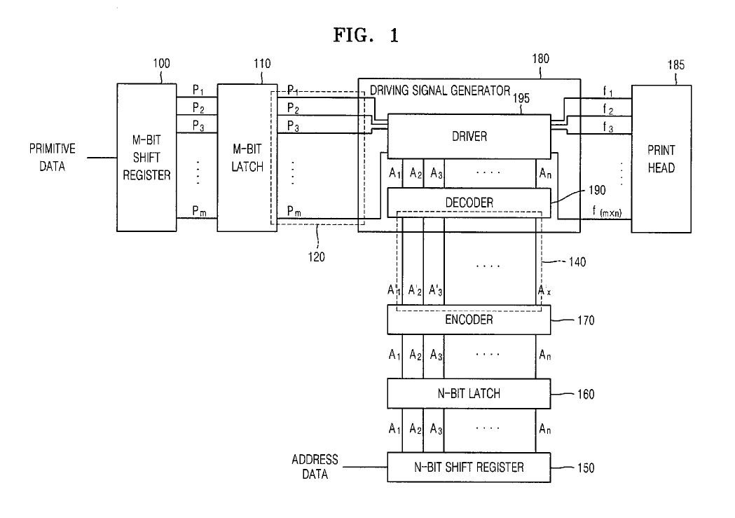

FIG. 1 is a block diagram illustrating a device to drive recording elements of an image forming apparatus according to an embodiment of the present general inventive concept. Referring to FIG. 1, the device includes an m-bit shift register 100, an m-bit latch 110, a primitive data bus 120, an n-bit shift register 150, an n-bit latch 160, an encoder 170, an address data bus 140, and a driving signal generator 180. The driving signal generator 180 includes a decoder 190 and a driver 195. The recording elements driving device of FIG. 1 drives a print head 185. The recording elements driving device of the image forming apparatus, as illustrated in FIG. 1, divides m×n recording elements into “m” groups each including “n” recording elements, and time-division-drives the recording elements.

A main controller (not illustrated) of the image forming apparatus generates and outputs primitive data and address data in synchronization with a clock signal in order to select and drive a nozzle(s) of the print head 185. The m-bit shift register 100 receives and stores the primitive data, and the n-bit shift register 150 receives and stores the address data. The m-bit latch 110 latches m-bit primitive data P1, P2, . . . , Pm stored in the m-bit shift register 100 when a load signal is input thereto. The n-bit latch 160 latches n-bit address data A1, A2., An stored in the n-bit shift register 150 when the load signal is input thereto.

The encoder 170 encodes the address data A1, A2, . . . , An output from the n-bit latch 160 into new address data A′1, A′2, . . . , A′x (x<n) so that neighboring recording elements share the address data bus 140. This reduces a number of lines of the address data bus 140.

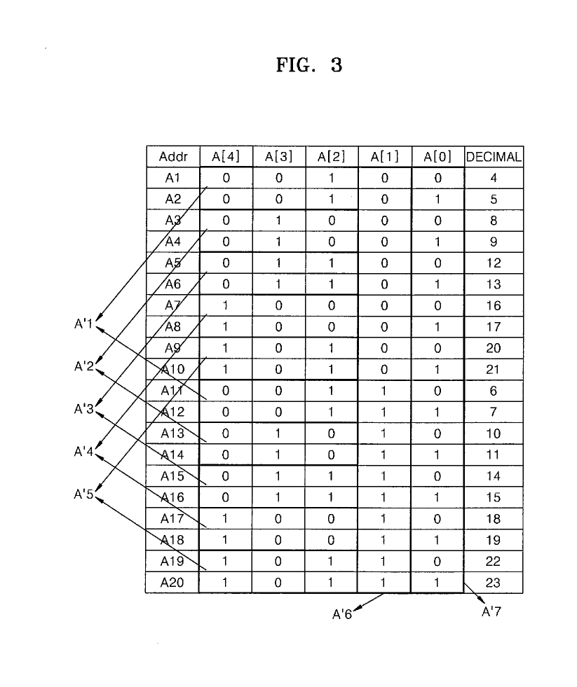

FIG. 3 illustrates a method of encoding the address data to make neighboring recording elements share an address data bus according to an embodiment of the present general inventive concept. The method of FIG. 3 may be performed by the encoder 170 and/or the recording elements driving device of FIG. 1. FIG. 3 illustrates a case in which one group includes twenty recording elements. 5-bit binary-coded decimal (BCD) codes are needed to create 20-bit address data. Thus, each address is converted into a 5-bit BCD code, as illustrated in FIG. 3.

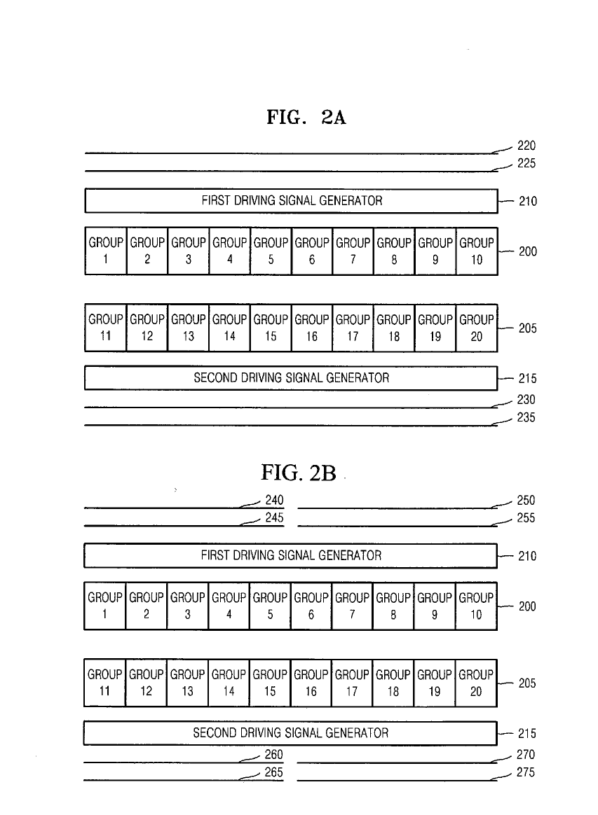

Referring to FIG. 3, there are five address sets 001, 010, 011,100 and 101 which have the same upper 3 bits (i.e., A[4], A[3], and A[2]). These address sets (i.e., sub-groups) of recording elements are referred to as A′1, A′2, A′3, A′4 and A′5, respectively. The first set A′1 includes addresses A1, A2, A11, and A12; the second set A′2 includes addresses A3, A4, A13, and A14; the third set A′3 includes addresses A5, A6, A15, and A16; the fourth set A′4 includes addresses A7, A8, A17, and A18; and the fifth set A′5 includes addresses A9, A10, A19, and A20. Furthermore, address bits A[1] are referred to as A′6 and are used to divide the addresses into an upper address and a lower address, and least significant bits A[0] are referred to as A′7. In other words, the 20-bit address data is divided into five sets (A′1, A′2, etc.) of four neighboring recording elements for each group of recording elements (see FIGS. 2A and 2B). The least significant bits A′6 and A′7 can be used to distinguish among the neighboring recording elements within each of the five sets of neighboring recording elements (A′1, A′2, etc.) while the more significant bits A′1, A′2, A′3, A′4, and A′5 selects one of the five sets of neighboring recording elements.

As described above, the address data is converted into BCD codes, neighboring addresses having the same upper predetermined bits of the BCD codes are grouped together in a set, and the same address is given to addresses belonging to the same set. By doing so, neighboring recording elements can share a data bus that transfers an address signal.

The 20-bit address data (e.g., A1 to A20) can be encoded into 7-bit data (e.g., A′1 to A′7) so that four recording elements share a single address data bus. In this case, the number of address data bus lines can be reduced from twenty to seven.

The decoder 190 included in the driving signal generator 180 receives and decodes the encoded address data A′1, A′2, . . . A′x to restore the original address data A1, A2, . . . , An.

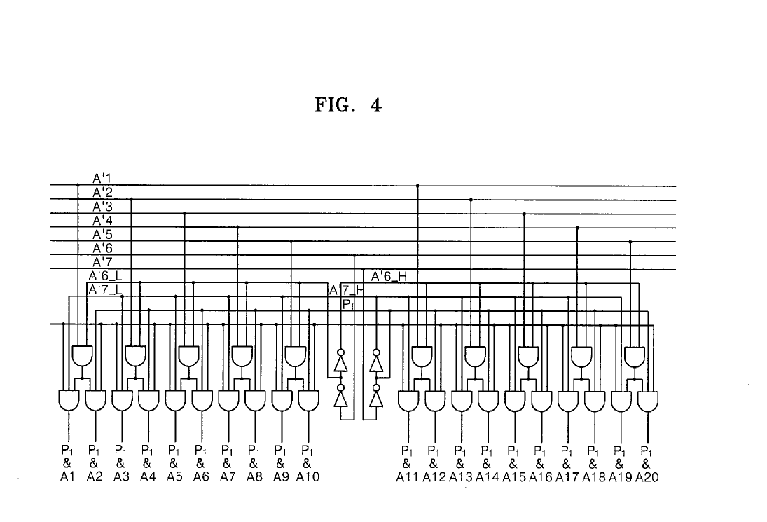

FIG. 4 illustrates a configuration of the decoder 190 to decode the address data according to an embodiment of the present general inventive concept. The decoder 190 decodes the address data encoded according to the method illustrated in FIG. 3. In FIG. 3, each address having the same upper 3 bits, that is, (A1, A2, A11, A12), (A3, A4, A13, A14), (A5, A6, A15, A16), (A7, A8, A17, A18) and (A9, A10, A19, A20), share a single data bus.

The decoder 190 connects a signal obtained by inverting the bit A′6 once using a single inverter to the addresses A1 through A10, and the decoder 190 connects a signal obtained by inverting the bit A′6 twice using two inverters to the addresses A11 through A20 so that upper and lower addresses are distinguished from each other using the bit A′6. The bit A′7 is inverted twice using two inverters, as illustrated in FIG. 4, so that an address having a value 0 and an address having a value 1, as illustrated in FIG. 3, can be distinguished from each other.

The driver 195 performs a logic AND operation on the decoded address data and the primitive data supplied through the primitive data bus 120 to select and drive corresponding recording elements.

FIGS. 2A and 2B illustrate configurations of data buses that transfer the primitive data and the address data according to an embodiment of the present general inventive concept. The data buses of FIGS. 2A and 2B may be included in the recording elements driving device of FIG. 1. FIGS. 2A and 2B represent a layout of a circuit board having nozzle groups (i.e., groups of recording elements) disposed thereon. Referring to FIG. 2A, a plurality of recording element groups are divided into two groups 200 (groups 1-10) and 205 (groups 11-20) such that two upper data buses 220 and 225 respectively transfer the primitive data and the address data to the upper groups 200, and two lower data buses 230 and 235 respectively transfer the primitive data and the address data to the lower groups 205. In this case, each of the primitive data buses 220 and 230 uses 10-bit data (that is, ten lines) in order to select one of the ten groups. Furthermore, when the address data is encoded using the method illustrated in FIG. 3, each of the two address data buses 225 and 235 can use seven lines. First and second driving signal generators 210 and 215 may decode the address data received thereby. For example, the first driving signal generator 210 can decode X bits (e.g., seven bits) of the address data received along the address data bus 225 into N bits (e.g., twenty bits) to drive selected nozzles within a group(s) selected from among the upper groups 200. Accordingly, the first driving signal generator 210 can selectively drive the upper groups 200 based on the decoded N bits of the address data and the primitive data received along the primitive data bus 220. The second driving signal generator 215 may operate in a similar manner to selectively drive the lower groups 205.

Referring to FIG. 2B, the plurality of recording element groups are divided into four arrangements of groups (groups 1-5, groups 6-10, groups 11-15, and groups 16-20). Two upper left data buses 240 and 245 respectively supply the primitive data and the address data to the left part of the upper groups 200 (i.e., groups 1-5), and two upper right data buses 250 and 255 respectively supply the primitive data and the address data to the right part of the upper groups 200 (i.e., groups 6-10). In addition, two lower left data buses 260 and 265 respectively supply the primitive data and the address data to the left part of the lower groups 205 (i.e., groups 11-15), and two lower right data buses 270 and 275 respectively provide the primitive data and the address data to the right part of the lower groups 205 (i.e., groups 16-20). That is, a total of eight data buses are used to supply the primitive data and the address data.

Referring to FIG. 2B, each of the four primitive data buses 240, 250, 260 and 270 uses 5-bit data (that is, five lines) in order to select one of five groups. When the address data is encoded using the method illustrated in FIG. 3, each of the four address data buses 245, 255, 265 and 275 uses seven lines. The first and second driving signal generators 210 and 215 illustrated in FIG. 2B may operate in a similar manner to the first and second driving signal generators 210 and 215 of FIG. 2A.

According to the embodiments of the present general inventive concept, when recording elements included in a print head are driven using primitive data and address data, the address data is encoded so that neighboring recording elements share an address data bus. Accordingly, the number of address data bus lines can be reduced, and a size of a print head chip can be decreased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A device to drive recording elements included in a print head and divided into a plurality of groups using primitive data to select groups to be driven from among the plurality of groups, and address data to select recording elements to be driven from among the recording elements belonging to the selected groups, the device comprising:
an encoder to encode the address data;
a decoder to decode the encoded address data to restore original address data;
an address data bus to connect the encoder with the decoder to transfer the encoded address data to the decoder;
a driver to drive the recording elements using the primitive data and the decoded address data; and
a primitive data bus to transfer the primitive data to the driver,
wherein the encoder encodes the address data so that neighboring recording elements among the recording elements share the address data bus.

2. The device of claim 1, wherein when the recording elements are divided into four groups, the address data bus includes four address data buses that transfer the address data to the four groups, respectively.

3. The device of claim 1, wherein when the recording elements are divided into four groups, the primitive data bus includes four primitive data buses that transfer the primitive data to the four groups, respectively.

4. The device of claim 1, wherein the encoder converts the address data into BCD codes so that recording elements corresponding to address data having the same predetermined upper bits of the BCD codes share the address data bus.

5. The device of claim 4, wherein each lower bit below the predetermined upper bits of the BCD codes is provided to the decoder through a single address data bus.

6. The device of claim 1, wherein the recording elements include ink jet nozzles to eject ink onto media to form images.

7. A device to drive nozzle groups in a print head, the device comprising:
a print head having a plurality of nozzle groups with N nozzles in each group; and
a driving signal generator to receive X address bits of an address signal indicating which nozzles within a selected nozzle group are to be driven and to decode the X address bits into N address bits, N being greater than X, and to drive nozzles of the selected nozzle group which correspond to the N address bits.

8. The device of claim 7, further comprising:
an encoder to receive N original address bits and to encode the N original address bits to the X address bits and to provide the X address bits to the driving signal generator.

9. The device of claim 8, further comprising:
at least one address bus having X lines to provide the X address bits from the encoder to a decoder of the driving signal generator.

10. The device of claim 9, wherein the driving signal generator and the at least one address bus are positioned on a circuit board to drive the print head, and the circuit board does not include the encoder.

11. The device of claim 7, wherein the driving signal generator receives a primitive data signal indicating the selected nozzle group, and the address signal selects nozzles within the selected nozzle group.

12. The device of claim 7, wherein the nozzle groups are divided into sets of neighboring nozzles each having Y nozzles, and the X address bits include Y bits to select a nozzle set within the selected nozzle group and L bits to select a nozzle within the selected nozzle set.

13. The device of claim 7, wherein:
the N address bits correspond to each of the nozzles in the selected nozzle group; and
the nozzle groups are each divided into a plurality of sets of neighboring nozzles such that first ones of the N address bits select one of the sets of neighboring nozzles and second ones of the N address bits select a nozzle from the selected set of neighboring nozzles.

14. An image forming apparatus, comprising:
a print head having a plurality of groups of nozzles, each group having a plurality nozzles;
an encoder to receive an address signal having a plurality of first bits to select from the plurality of nozzles in a selected nozzle group and to reduce the first bits in the address signal to a plurality of second bits based on relative locations of the nozzles within the selected nozzle group; and
a driving signal generator to receive the second address bits, to restore the first bits of the address signal, and to drive the nozzles in the selected nozzle group based on the restored first bits.

15. The apparatus of claim 14, further comprising:
a first shift register to receive primitive data;
a first latch to latch the primitive data and to provide the primitive data to the driving signal generator to indicate the selected nozzle group;
a second shift register to receive the first bits of the address signal; and
a second latch to latch the first bits of the address signal and to provide the first bits to the encoder.

16. The apparatus of claim 14, wherein the print head comprises:
a circuit board having the nozzle groups and the driving signal generator arranged thereon, the nozzle groups being divided into a plurality of sets of neighboring nozzle groups;
a plurality of address buses disposed on the circuit board to correspond to the sets of neighboring nozzle groups, each nozzle group in the respective sets of neighboring nozzle groups sharing a single address bus; and
at least one primitive data bus to indicate the selected nozzle group.

17. The apparatus of claim 16, wherein the address buses and the at least one primitive data bus receive address data and primitive data, respectively, from a source not positioned on the circuit board and provides the address data and the primitive data, respectively, to the driving signal generator.

18. The apparatus of claim 16, wherein the nozzle groups are arranged in a first row and a second row on the circuit board, the first and second rows having first and second primitive data buses, respectively, in communication therewith and first and second data buses, respectively, in communication therewith.

19. The apparatus of claim 16, wherein the nozzle groups are arranged in a first row and a second row on the circuit board, the first and second rows each having at least one primitive data bus in communication therewith and at least two address data buses in communication therewith.

20. A method of driving a print head having a plurality of nozzle groups with N nozzles in each group, the method comprising:
receiving X address bits of an address signal indicating which nozzles within a selected nozzle group are to be driven;
decoding the X address bits into N address bits, N being greater than X; and
driving nozzles of the selected nozzle group which correspond to the N address bits.

21. The method of claim 20, wherein:
the N address bits correspond to each of the nozzles in the selected nozzle group; and
the nozzle groups are each divided into a plurality of sets of neighboring nozzles such that first ones of the N address bits select one of the sets of neighboring nozzles and second ones of the N address bits select a nozzle from the selected set of neighboring nozzles.
